(19) United States
(12) Patent Application Publication
(10) Pub. No.: US 2002/0159931 A1
(43) Pub. Date: Oct. 31, 2002

(54) Method and facility for recycling organic wastes without pollution

(76) Inventor: Huang-Chuan Chen, Taipei (JP)

Correspondence Address: BACON & THOMAS, PLLC, 4th Floor, 625 Slaters Lane, Alexandria, VA, 22314-1176, US

(21) Appl. No.: 09/842,867

(22) Filed: Apr. 27, 2001

(51) Int. Cl. B01L 7/00; C01B 31/02

(52) U.S. Cl. 422/198; 423/445 R; 422/190; 422/224; 422/225

(57) ABSTRACT

A method and a facility for recycling organic wastes without pollution, wherein, chars of high quality generated are removed from a reactor when pyrolysis of the cokes is completed to the degree of 80% to be dealt with in the subsequent primary and secondary treatment tanks in order to completely wipe out the residual organic volatile compounds (VOC) resided in the chars to get refined pure chars. The gas generated from the reactor is separated and cooled and is directly converted into completely recoverable oil resource and gas; this can reduce the time for reaction and increase the amount of treatment of the organic wastes and the efficiency as well as the rate of the reaction; By the present invention, e.g., the heating cycle of the reactor for 2,000 kg of waste tires can be reduced to 2.5-3.5 hrs. Such method and facility for recycling organic wastes without secondary contaminant can meet the requirement of environmental protection and fit the spirit of UNFCCC.

### BACKGROUND OF THE INVENTION

1. Field of the Invention

The present invention is related to a method and a facility for recycling organic wastes without pollution, wherein, waste tires are treated by pyrolysis to become oil of superior quality in a way of fast mass treatment without secondary contaminant to meet the requirement of environmental protection and fit the spirit of UNFCCC; and especially related to such a method and a facility wherein a reactor and a furnace are installed separately and the reactor is heated by flue gas of the furnace through a jacket of the reactor, wherein, a primary and a secondary coke treatment tank are both operated under vacuum operation, and organic volatile compounds (VOC) resided in cokes can be reduced to less than 5%. The organics are shredded into one-inch size or less before feeding to the reactor. An agitator of the reactor is rotated smoothly and continually to increase efficiency of heat transfer and reaction rate.

2. Description of the Prior Art

Petrochemical and car industries have been highly developing for decades, large amounts of tires and plastics have been being consumed; while bacteria uneasily digest organic wastes, organic wastes are not suitable for the disposal way of landfill, thus the problem in getting a solution for disposing waste tires and plastics have been long annoying the environmental organizations. Scientists and engineers have been continuously studying recovery of the organic wastes such as waste tires. There are many ways to dispose waste tires. Landfill was the major disposal means in the past. Due to limitation of the resource of land, landfill isn't suitable. And traditional pyrolysis isn't well popular, because pyrolysis of waste tires can only be completed at the temperature of 800° C.˜1,000° C., and its reaction time is overly long and uneconomic; the equipment cost thereof is high while the level of safety in operation is low; furthermore, the char products of low grades from such pyrolysis limit themselves in marketing. In the past couple decades of years, more than 36 pyrolysis projects have been developed in the U.S.A., only very few are still operated today. Statistically, only 0.14% of waste tires had been treated using the conventional pyrolysis process in the U.S.A. in 1997.

The major ingredients of tires are natural rubber (NR), synthetic rubber and the fillers including carbon black, anti-oxidant and vulcanization agent etc. As to the synthetic rubber, styrene-butadiene-rubber (SBR) and cis-polybutadiene rubber (BR) are used the most for tires today. In general, 65%˜70% of the outer surfaces of tires are made of SBR materials. Elasticity of NR is decreased at higher temperature, while BR still maintains a better condition. Therefore, for some higher grade of tires, BR is substituted for NR to blend with SBR as the master ingredient of tires.

Pyrolysis technology has been applied for many years in disposing waste tires; this technology is well accepted and commercialized. Under the conditions of anaerobics and high temperatures, the large carbon chains of organic wastes are cut and degraded to generate the resources of gas, oil and char. This process is called pyrolysis, different from an incineration method of which these wastes are completely burned out to produce CO₂, H₂O and ash residue. The energy of flue gas from incineration can be recovered to generate steam and power; this method disposes tires only in a negative way though, it can't turn organic wastes into valuable resources. Furthermore, the waste gas and CO₂ generated from incineration of organic wastes cause adverse impact to the environment.

Pyrolysis of organic wastes can generate recoverable pyro-gas, oil resource and coke. In conventional pyrolitic reaction, organic wastes are placed in a horizontal reactor which is continuously heated directly to decompose the chips of the organic wastes into char and pyro-gas. The pyro-gas after the reaction is cooled to obtain oil resource, while the residual material is cooled to obtain cokes. By the fact that quality of the oil resource and the molecular structure of the decomposed material are much related to the temperature of pyrolysis, Hydrogen sulfide (H₂S) in the pyro-gas is generated by cracking of the long molecular chains of the decomposed material to obtain molecules of alkylene hydrocarbons and H₂. Hydro-desulfurization reaction happens between H₂ and sulfur molecules at higher temperature. Normally, the higher the reaction temperature and the longer the reaction time are, the higher the yield of pyro-gas and pyro-oil will be. However, when the reaction temperature is too high, it will happen that part of oil causes the side reaction of hydro-cracking; consequently the yield of oil will rather be decreased. Proportionally, content of pyro-gas will increase (C₃-C₅ ingredients are more).

Since thermal conductivity of waste tires is extremely low and the traditional pyrolysis method treats organic wastes in a horizontal reactor, the reactor must be heated continually to speed up pyrolysis to lower the ratio of organic volatile compounds (VOC) of the char. However, overly high temperature for pyrolysis is unfavorable to the generation of carbon black. Accordingly, although conventional pyrolysis of organic wastes can generate recoverable pyro-gas, oil resource and chars, pyrolysis of organic wastes is proceeded continually in the same reactor till the end of the reaction, thereby temperature required for the reaction is high, and time for the reaction of every batch of organic wastes is long, adversely, amount of treatment of every batch is restrained. Moreover, the process of pyrolysis is hard to control, and thereby it is unable to get char of good quality, yield of oil resource is low, and too much pyro-gas containing sulfur molecules is generated, hence the organic wastes can not be effectively converted into resources.

### SUMMARY OF THE INVENTION

In view of this, the main object of the method and facility for recycling organic wastes without pollution of the present invention is to dispose waste tires by using a char treatment facility with two treatment stages subsequent to the reactor, wherein, char of high quality generated is removed from the reactor when pyrolysis of the char is completed to the degree of 80% to be dealt with in the subsequent primary and secondary treatment tanks. The residual organic volatile compounds (VOC) of the tire chips in the reactor are further removed by heating separately, this can reduce the time for the reaction and increase the amount of treatment of every batch of organic wastes and the efficiency as well as the rate of the reaction; and can prevent the char from overheating and overlong treatment which induce morphological change thereof, thus can produce cokes of high quality. By the present invention, the heating cycle of the reactor for 2,000 kg of waste tires can be reduced to 2.5-3.5 hrs. These chars can be further refined to get raw materials of carbon black or active carbon.

Another object of the method and facility for recycling organic wastes without pollution of the present invention is to recover pyro-oil needed by the markets from the pyro-gas generated by the reactor directly by a primary separator and a condenser without passing through the above stated two treatment stages, wherein, the non-condensable gas is reused as the heating source for the reactor, and the excess gas is reused as fuel for cogeneration or industrial boiler. There is not at all a problem of secondary air pollution by virtue that the pyro-gas was burned out.

Another object of the method and facility for recycling organic wastes without pollution of the present invention has the reactor and the furnace thereof installed separately from each other; wherein, the external wall of the reactor is enclosed by a jacket which is communicated with the flue of the furnace. The fresh tire chips are shredded into one-inch size or less before feeding to the reactor; the tire chips are heated by flue gas in the reactor generated by the furnace and can be heated homogenously to obtain chars of better quality.

A further object of the method and facility for recycling organic wastes without pollution of the present invention is to install the reactor upright, wherein, the reactor has an agitator provided with a plurality of spiral type impellers rotating clockwise and counterclockwise alternately. These tire chips are continually and sufficiently stirred during mild rotation of the reactor, every tire chip can thus be heated homogenously and can be split and decomposed, and heat transferring efficiency and rate of the reaction can be enhanced.

A further object of the method and facility for recycling organic wastes without pollution of the present invention is to have 20% of steel wires retained in the tire chips which can rub the wall of the reactor to obtain higher heat transferring rate of the wall. The steel wires resided in cokes are finally taken out by a magnetic separator and are sold to steel plants.

The technique of pyrolysis of the present invention can get evident effects in disposing the organic wastes such as waste tires, rubber and plastic etc. Ingredients of the organic wastes are various, and operating conditions of the pyrolysis such as operating temperature, pressure, reaction time and proportion of the catalyst added to the reactor depend on the chemical structure of organic wastes.

The present invention will be apparent in the particular process scheme with key equipments of the pyrolysis after reading the detailed description of the preferred embodiment thereof in reference to the accompanying drawings.

### BRIEF DESCRIPTION OF THE DRAWINGS

FIG. 1 is a flow chart of the method and facility for recycling organic wastes without pollution of the present invention;

FIG. 2 is a schematic view showing treatment of chars in the present invention;

FIG. 3 is a schematic view showing the flow way of the flue gas generated by the furnace of the present invention;

FIG. 4 is a schematic view showing the flow chart of treatment of pyro-gas and pyro-oil generated by the pyrolysis of the present invention;

FIG. 5 is a schematic view showing the flow chart of treatment of chars generated by the pyrolysis of the present invention;

FIG. 6 is a sectional view showing the structure of the reactor of the present invention.

### DETAILED DESCRIPTION OF THE PREFERRED EMBODIMENT

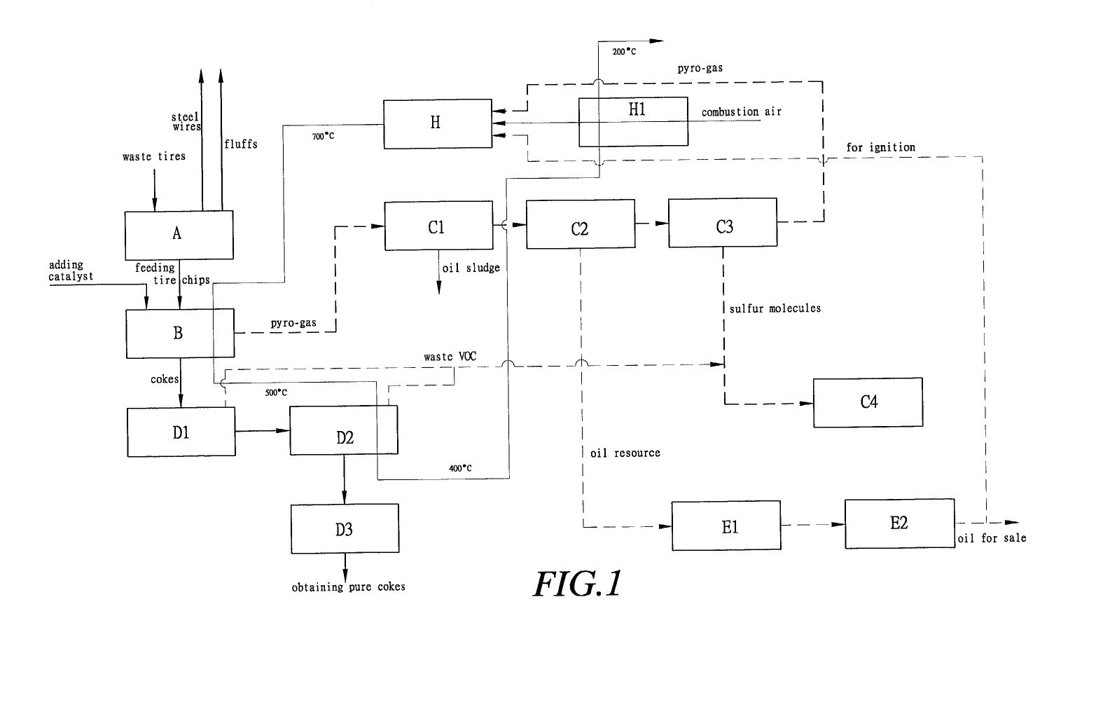

Referring firstly to FIG. 1, the equipment required by the process of pyrolysis for the method and facility for recycling organic wastes without pollution of the present invention is depicted herein. Wherein, a reactor (B) is the main equipment accompanied with a furnace (H) for generating flue gas, a primary separator (C1) and a condenser (C2) for recovering pyro-oil, a gas holder (C3) for storage of pyro-gas, an oil intermediate tank (E1), an oil storage tank (E2) for storage of the pyro-oil, a char primary treatment tank (D1), a coke secondary treatment tank (D2) and a char cooling tank (D3) for char treatment, and a raw tire shredder (A) for shredding raw tires before the pyrolysis. Each apparatus in the facility is connected with pipes and char transferring equipment to automatically complete the plant operations of delivery of the pyro-gas, the oil resource and chars.

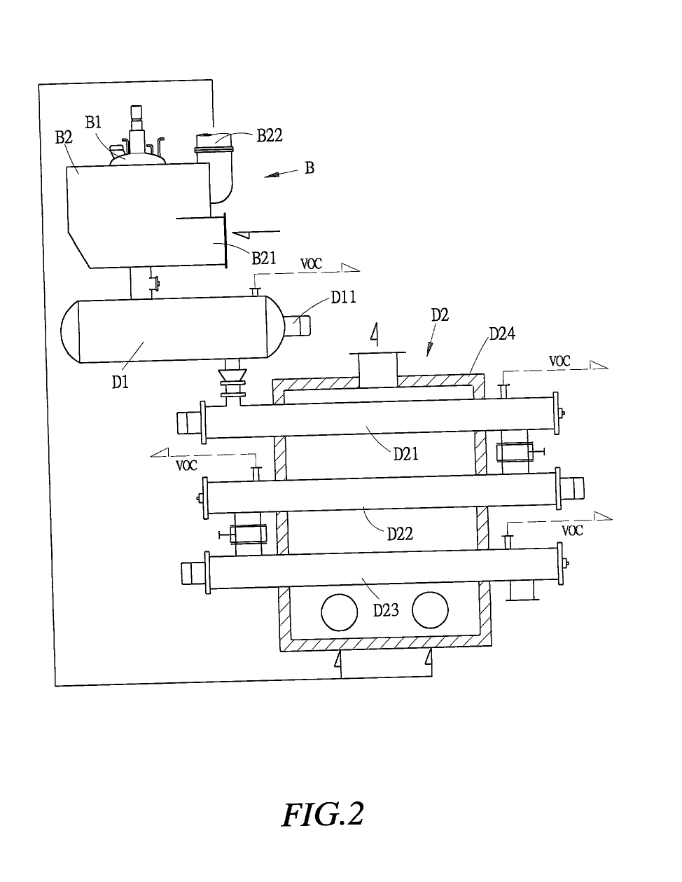

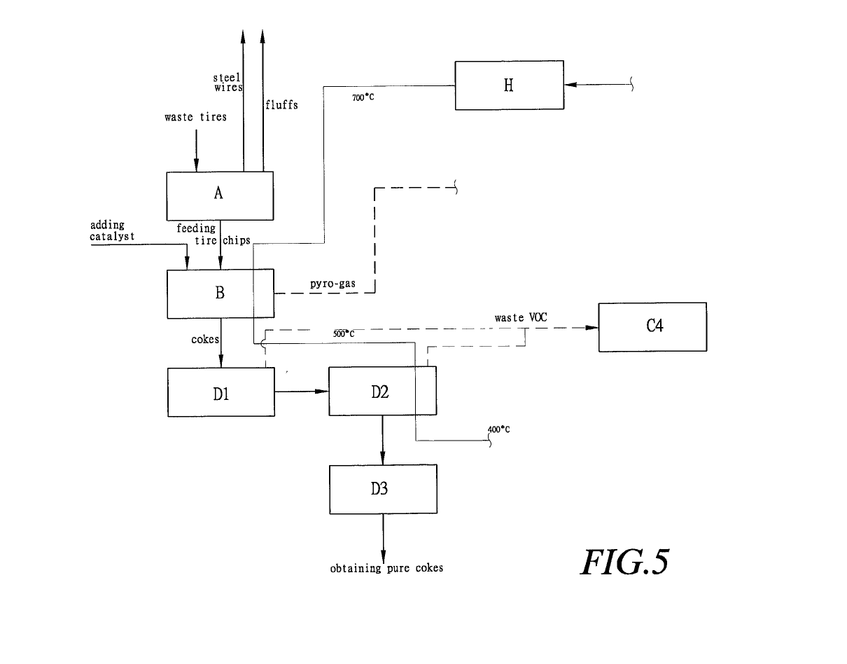

The present invention is characterized by that: the char primary treatment tank (D1), the char secondary treatment tank (D2) and the char cooling tank (D3) all for treating chars are provided behind the reactor (B). Referring also to FIGS. 2 and 5, chars of high quality generated is removed from the reactor (B) when pyrolysis of the chars is completed to the degree of 80% to be dealt with in the subsequent primary and secondary treatment tanks (D1), (D2). The residual organic volatile compounds (VOC) of the tire chips in the reactor are further removed by heating separately, this can reduce the time for the reaction and increase the amount of treatment of every batch of organic wastes and the efficiency as well as the rate of the reaction; and can prevent the chars from overheating and overlong treatment which induce morphological change thereof, thus can produce chars of high quality. These chars can be further refined to get raw materials of carbon black or active carbon.

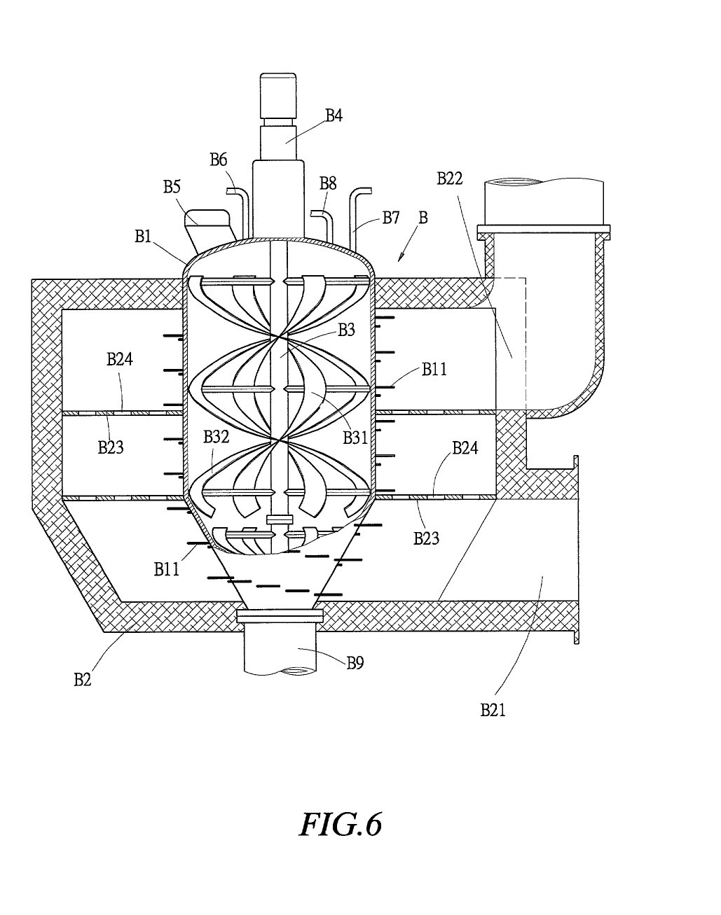

Referring to FIG. 5 and FIG. 6, the reactor (B) and the furnace (H) of the invention are installed separately from each other; wherein, the external wall of the reactor (B) is equipped with a jacket (B2) which is communicated with the flue of the furnace (H). The hot gas generated by the furnace (H) heats the reactor (B) which has a sealed body (B1) with high thermal conductivity and is provided with a number of heating fins (B11) on its outer surface and inside the heating space of the jacket (B2) for increasing the effect of heat transferring. The jacket (B2) is provided with an inlet nozzle (B21) in communication with the flue of the furnace (H) and a hot gas outlet nozzle (B22) for discharging the circulating hot gas to the secondary treatment tanks (D2). A plurality of plates (B23) are installed to partition the heating space of the jacket (B2) for guiding flow direction of the flue gas between the inlet nozzle (B21) and the outlet nozzle (B22), and a plurality of holes (B24) are provided on these plates (B23) for passing the flue gas homogenously. Thereby, when hot gas enters the jacket (B2) from the inlet nozzle (B21), it can mildly pass through the holes (B24) and extend through the plates (B23) in sequence, and finally is discharged out of the jacket (B2) to largely increase the time of heating for the reactor (B).

There are a number of nozzles on the top of the reactor (B), including a nozzle (B5) for feeding fresh tire chips, a nozzle (B6) for feeding catalyst, a nozzle (B7) as an outlet of gas generated and a nozzle (B8) for pressurizing the reactor with nitrogen; a discharge nozzle for chars (B9) is installed on the bottom of the body (B1) of the reactor (B) for injecting the tire chips to be treated, the catalyst required and nitrogen needed by positive pressurizing operation are injected into the body (B1). The discharge nozzle (B9) is sealed in favor of proceeding of the pyrolysis, pyro-oil and pyro-gas are discharged out of the reactor (B) via an exhausting nozzle (B7) favorable to subsequent separation of the oil and gas, and cooling process. The chars after reaction can be discharged out of the reactor (B) from the discharge nozzle (B9) for subsequent refining. Additionally, an agitator (B3) with a plurality of spiral type impellers is installed inside the reactor (B) and is rotated by a motor (B4) provided outside the body (B1). The impellers include clockwise rotating impellers (B31) and counterclockwise rotating impellers (B32) arranged alternately mutually. These tire chips are continually and sufficiently stirred during mild rotation of the reactor (B), every tire chip can thus be heated homogenously and can be split and decomposed, and different mechanisms of reaction by low heat transferring efficiency of rubber can be avoided, thus chars of better quality can be obtained.

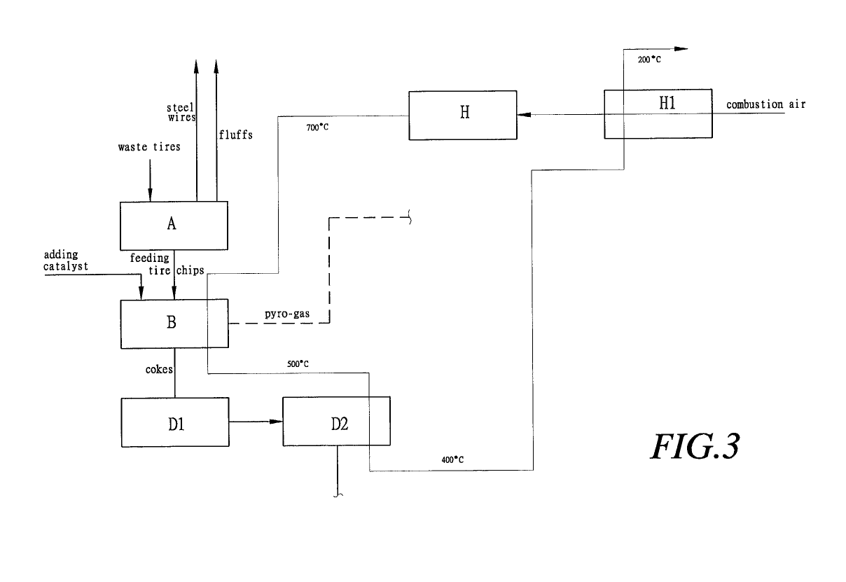

The source of hot gas used in this invention is obtained from the hot flue gas of high temperature generated from air heated in the reactor (B). As shown in FIG. 3, combustion air is preheated through an air pre-heater (H1) inside the furnace (H) to generate 700° C. temperature in the hot flue gas which is fed as a heating medium for the reactor (B). The temperature of the cold flue gas exhausted from the reactor (B) is cooled down to 500° C. It is reused to heat the char secondary treatment tank (D2). The temperature of the flue gas exhausted from the char secondary treatment tank (D2) is lowered to about 400° C. The source of hot gas can be sent back to the air pre-heater (H1), the hot gas with the temperature of 400° C. contacts indirectly with the air in the air pre-heater (H1) and is discharged after heating.

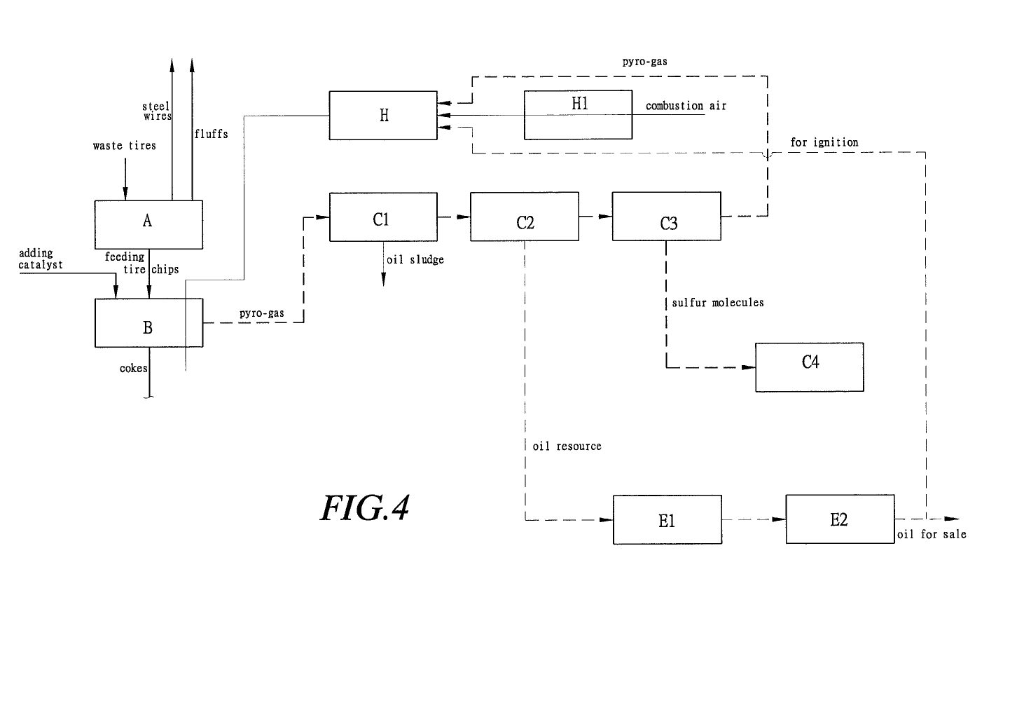

During pyrolysis of the waste tires in the present invention, the waste tires shall be shredded into tire chips of one-inch size and all the steel wires and fluffs shall be stripped off before feeding to the reactor (B). Referring to FIG. 4, the gas generated from the reactor (B) passes through the primary separator (C1) to evolve oil sludge, later on, it is sent to the condenser (C2) for recovering the pyro-oil. The non-condensable gas escaping from the condenser (C2) is sent to the gas holder (C3) for storage. It is reused as a fuel source for the furnace (H). The excess pyro-gas is burned out in a flare (C4) completely. The pyro-oil recovered from the condenser (C2) is temporarily stored in the oil intermediate tank (E1) and pumped back to the oil tank (E2) for storage later. Parts of them are used to ignite the furnace (H).

As shown in FIG. 2 and FIG. 5, the residual char obtained from the reaction of pyrolysis of the waste tires is generated in the reactor (B) and are discharged to the char primary treatment tank (D1). The stirring motion in another agitator in the primary treatment tank (D1) discharges the residual volatile organic compounds on the surface of chars. Later on, the chars treated are delivered to the char secondary treatment tank (D2) for further refining. The coke secondary treatment tank contains three sets of pipe heaters (D21, D22 and D23) installed inside a heating chamber (D24) in sequence. The pipe heaters (D21, D22 and D23) serially stir and heat the chars inside with flue gas in the heating chamber (D24) to make a secondary pyrolysis of the chars. The residual volatile organic compounds (VOC) resided in the cokes are completely wiped out to be less than 5%. Both the char primary treatment tank and the char secondary treatment tank are operated under vacuum condition. The refined chars are finally cooled down through the char cooling tank (D3). They can be further refined as raw materials of carbon black or active carbon. The steel wires resided in tire chips are good for keeping the heat transferring rate of the inner wall of the reactor (B). They are finally collected from the chars through the magnetic separation and sieving procedure and can altogether be sold to steel plants.

The method and facility for recycling organic waste without pollution of the present invention make cost lower by that the generated pyro-gas is reused as a heating source for the reactor (B) and the pyro-oil and chars generated can be sold to the markets. The present invention not only disposes organic wastes, but also generates valuable resources from the organic wastes without pollution, and gets rid of the secondary air pollution in processing the organic wastes; thereby they are excellent for disposing organic wastes. And more, the resources of the chars, pyro-oil and pyro-gas resulted are of high quality.

Having thus described my invention, what I claim as new and desire to be secured by Letters Patent of the United States are:

1. A method for recycling organic wastes without pollution, wherein, a char treatment facility with two treatment stages subsequent to a reactor is used for organic wastes, and wherein, cokes of high quality generated are removed from said reactor when pyrolysis of said chars is completed to the degree of 80% to be dealt with in a subsequent 20% refining process, residual organic volatile compounds (VOC) of said organic wastes in said reactor are further removed by heating separately, thus time for reaction is reduced and the amount of treatment of every batch of said organic wastes and the efficiency as well as rate of said reaction are increased; and overheating and overlong treatment which induce morphological change of said chars is prevented, thus chars of purer quality is obtained, said cokes are further refined to get raw materials of carbon black or active carbon.

2. A facility for recycling organic wastes without pollution, wherein, an equipment required by a process of pyrolysis for said facility is comprised of a reactor and a furnace, said facility is characterized by that: a char primary treatment tank, a char secondary treatment tank and a char cooling tank all for treating chars are provided behind said reactor, chars of high quality generated are removed from said reactor to get into said char primary treatment tank, stirring motion in an agitator in said primary treatment tank discharges residual volatile organic compounds on the surfaces of said chars, said discharged chars are delivered to said char secondary treatment tank which contains three sets of pipe heaters installed in sequence, said pipe heaters serially stir and heat said chars inside to make a secondary pyrolysis of said chars, said residual volatile organic compounds (VOC) resided in said chars are completely wiped out by having both said char primary treatment tank and said char secondary treatment tank operated under vacuum condition, refined chars are finally cooled down through said char cooling tank to get pure cokes which are further refined as raw materials of carbon black or active carbon.

3. A facility for recycling organic wastes without pollution as in claim 2, wherein, said reactor is an enclosed body made of metal with high heat conductivity, a jacket encloses said reactor and is connected with a flue gas of said furnace, said jacket is provided with an inlet nozzle in communication with said flue and a hot gas outlet nozzle for discharging circulating hot gas to said secondary treatment tanks, said hot gas exhausted from said furnace enters said jacket to heat said reactor and then to heat said char secondary treatment tank.

4. A facility for recycling organic wastes without pollution as in claim 3, wherein, a plurality of plates are installed to partition the heating space of said jacket for guiding flow direction of flue gas between said inlet nozzle and said outlet nozzle, and a plurality of holes are provided on said plates for passing said flue gas homogenously, when hot gas enters said jacket from said inlet nozzle, it mildly passes through said holes and extend through said plates in sequence, and finally is discharged out of said jacket to largely increase the time of heating for said reactor.

5. A facility for recycling organic wastes without pollution as in claim 3, wherein, said reactor is provided with a number of heating fins on its outer surface and inside the heating space of said jacket for increasing the effect of heat transferring.

6. A facility for recycling organic wastes without pollution as in claim 2, wherein, a number of nozzles are provided on the top of said reactor, including a nozzle for feeding fresh tire chips, a nozzle for feeding catalyst, a nozzle as an outlet of gas and a nozzle for pressurizing, and a discharge nozzle for chars is installed on the bottom of the body of said reactor.

7. A facility for recycling organic wastes without pollution as in claim 2, wherein, said reactor is installed upright and has an agitator which is provided with a plurality of spiral type impellers rotating clockwise and counterclockwise alternately by driving of a motor outside of said reactor.

8. A facility for recycling organic wastes without pollution as in claim 2, wherein, said facility includes a primary separator, a condenser and a gas holder for pyrolysis; an oil intermediate tank for disposing oil resource obtained by cooling pyro-oil, an oil storage tank, a shredder for shredding wastes before said pyrolysis, each apparatus in said facility is connected with pipes to automatically complete the operations of delivering pyro-gas, said oil resource and said cokes.

9. A facility for recycling organic wastes without pollution as in claim 2, wherein, an air pre-heater is installed ahead of said furnace to preheat combustion air.
